(19) United States
(12) Patent Application Publication
(10) Pub. No.: US 2003/0126138 A1
(43) Pub. Date: Jul. 3, 2003

(54) Computer-implemented column mapping system and method

(76) Inventors: Shirley J.R. Walker, Cary, NC (US); Paul A. Polo, Durham, NC (US); Steven E. Giles, Raleigh, NC (US)

Correspondence Address: Jones, Day, Reavis and Pogue, North Point, 901 Lakeside Avenue, Cleveland, OH, 44114, US

(21) Appl. No.: 09/968,064

(22) Filed: Oct. 1, 2001

(51) Int. Cl. G06F 7/00

(52) U.S. Cl. 707/100

(57) ABSTRACT

A computer-implemented method and system for mapping a computer data input column to a computer data output column. The input column and the output column have attributes. Information is received about at least one of the input column attributes and at least one of the output column attributes. At least one of the input column attributes is compared to at least one of the output column attributes to determine a likelihood ranking for mapping the input column to the output column. The likelihood ranking is between zero and one-hundred percent certain. The decision whether to map the input column to the output column is based upon the likelihood ranking.

### BACKGROUND AND SUMMARY

The present invention is generally directed to the field of data warehouse development. More specifically, the present invention is directed to column mapping methods and systems.

In data warehouses, the process of transforming the data of input tables to output tables is called mapping. A data warehouse can contain many mappings as input tables are manipulated to form the output tables a user requires. However, present computer tools do not efficiently allow column mapping to be performed. The present invention overcomes this inefficiency and other disadvantages. In accordance with the teachings of the present invention, a computer-implemented system and method are provided for mapping a computer data input column to a computer data output column. The input column and the output column have attributes. Information is received about at least one of the input column attributes and at least one of the output column attributes.

At least one of the input column attributes is compared to at least one of the output column attributes to determine a likelihood ranking for mapping the input column to the output column. The likelihood ranking is between zero and one-hundred percent certain. The decision whether to map the input column to the output column is based upon the likelihood ranking.

It should be noted that these are just some of the many aspects of the present invention. Other aspects will become apparent upon reading the detailed description of the preferred embodiment set forth below.

### BRIEF DESCRIPTION OF THE DRAWINGS

The present invention provides many advantages, as will become apparent from the following description when read in conjunction with the accompanying drawings, wherein:

FIGS. 1-3 are block diagrams depicting a system to map input columns to output columns;

FIG. 4 is a data structure chart depicting examples of data contained in resultant column mappings;

FIG. 5 is a graphical user interface depicting possible column mapping matches;

FIGS. 6 and 7 are flow charts depicting overall process steps to perform column mapping;

FIG. 8 is a flow chart depicting use of multiple mapping techniques to perform column mapping;

FIG. 9 is a flow chart depicting use of a user-defined mapping technique to perform column mapping;

FIG. 10 is a graphical user interface for users to expressly define mappings;

FIG. 11 is a flow chart depicting use of a same name-based technique to perform column mapping;

FIG. 12 is a flow chart depicting use of a character comparison technique to perform column mapping;

FIG. 13 is a flow chart depicting use of a previous mapping technique to perform column mapping;

FIG. 14 is a flow chart depicting use of the data format technique to perform column mapping; and

FIG. 15 is a block diagram depicting a system to map input columns to output columns that includes use of a concept cluster module to identify column mappings.

### DESCRIPTION OF EXAMPLES OF THE CLAIMED INVENTION

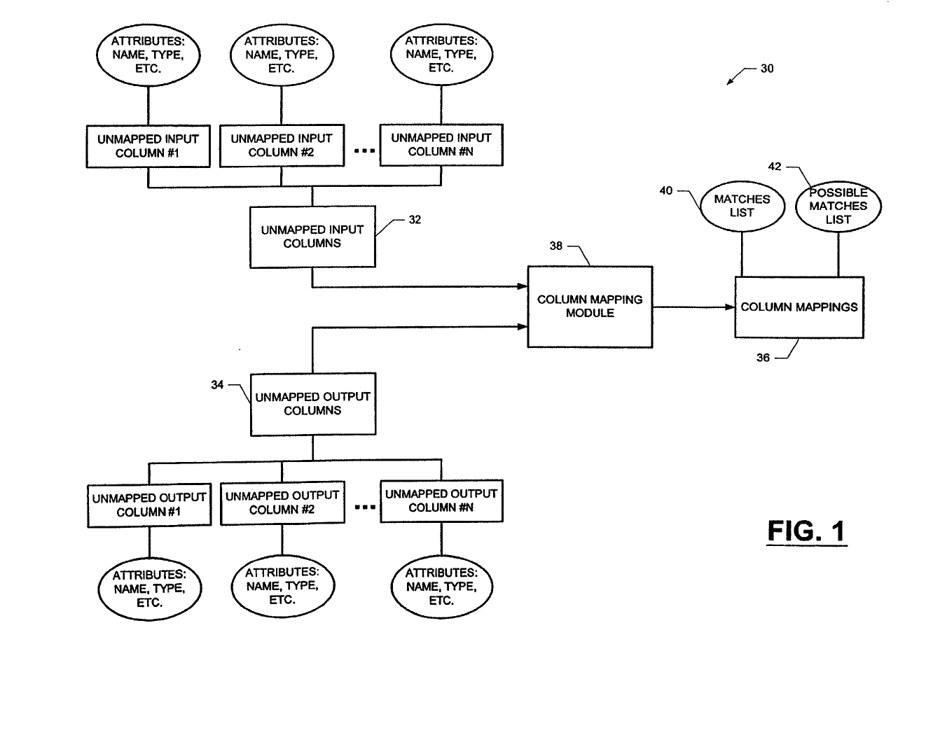

FIG. 1 depicts a system 30 that efficiently and intelligently maps input columns 32 to output columns 34. System 30 uses one or more multiple mapping techniques to perform the mapping. The mapping system 30 automatically determines the optimal column mappings 36 for each unmapped output column 34 based upon the best possible match. The mapping system 30 initially executes one or more efficient mapping techniques first. If a match is not found initially, more intensive mapping techniques are invoked until an optimal match is determined. The mapping may involve matching columns of differing names, differing types, converting types when appropriate, deriving new input columns, discovering repetition and automating the repetition across mappings, etc.

The unmapped input columns 32 include the original columns from the input tables and any new columns that have been derived from the input tables. The derived input columns may be constants, mathematical functions, or other values. The process of matching an input column to an output column is termed column mapping. Column mappings may be of two types, “one-to-one” or “derived”. A one-to-one column mapping is a straight data transfer from the input column to the output column. A derived column mapping involves some exploitation or calculation performed on the data in the original input column to transform that data into the values for the output column. For each mapping in a warehouse, every column in the output table requires a column mapping.

The mapping system 30 includes a column mapping module 38 to analyze the probability that an input column may map to an output column. If the column mapping module determines that an input column maps with approximately 100% certainty to an output column, the mapping is stored in the matches list 40. However, if uncertainty exists as to the mapping, then the column mapping module 38 stores the mapping in a possible matches list 42. Mapping uncertainty typically arises when attributes of an input column do not match exactly with attributes of an output column. For example, the name of an input column may differ slightly or significantly from the name(s) of its one or more corresponding output columns. As another example, the data type of an input column may not match the data type(s) of its one or more corresponding output columns.

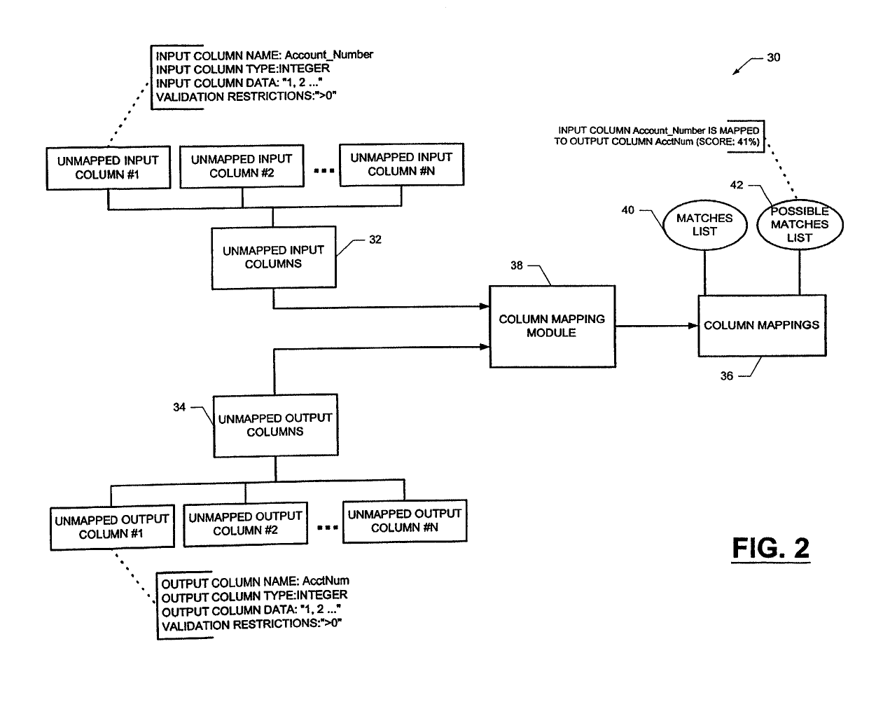

FIG. 2 provides an example of the mapping performed by system 30. In this example, an unmapped output column's name is “AcctNum” with a data type of integer, and column data of “1, 2, . . . ”. The column has a verification attribute that the account number value supplied for this field must be greater than zero. An unmapped input column's name is “Account_Number” with a data type of integer, and column data of “1, 2, . . . ”. The column has a verification attribute that the account number value supplied for this field must be greater than zero. The mapping system 30 analyzes the attributes of each column to assess their similarity. This may include assessing the degree of similarity of portions of their names, how similar the columns' verification restrictions are, and/or how similar the data types/formats. The mapping system 30 may use only one of the attribute assessments to determine a mapping likelihood ranking or may pool two or more of the assessments to generate a composite likelihood ranking. Because in this example the mapping system has determined that that these two columns are possible matches, the match is stored along with the ranking in the possible matches list.

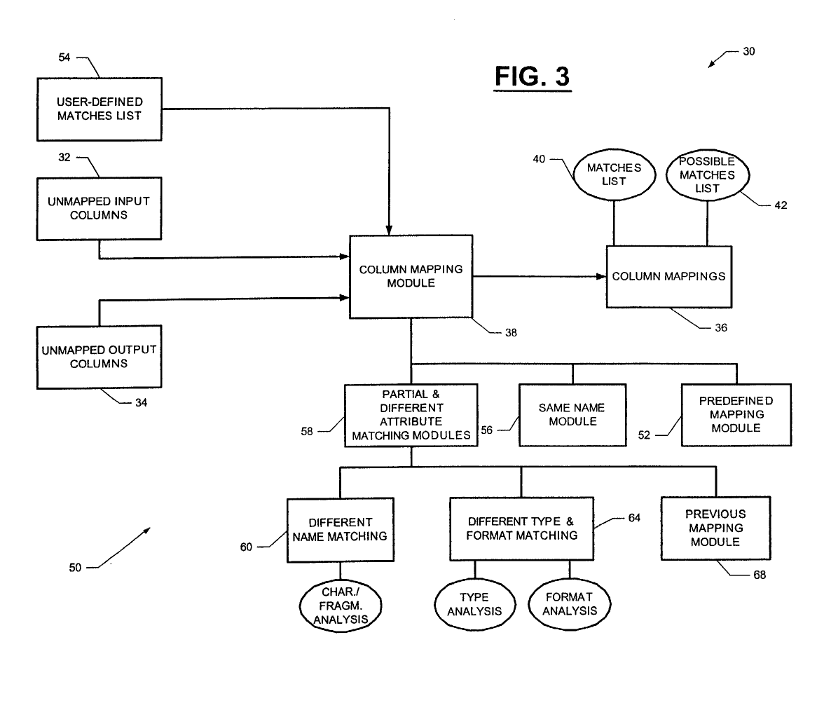

FIG. 3 depicts the column mapping module 38 and exemplary modules 50 it uses to perform the column mapping. Exemplary modules 50 may include a predefined mapping module 52. The predefined mapping module 52 examines a user-defined matches list 54 for mapping. Each output column in the list 54 may have multiple input columns mapped to it. The list 54 may specify if there are any input columns that an output column should not be mapped to.

The column mapping module 38 also uses a “same name” module 56 to perform column mapping. The same name module 56 examines the name of an input column with the name of the output column. If the names match, then the two columns are mapped and added to the matches list 40 with a 100% ranking. In addition, the same name module 56 stores in the column mappings 36 matches that have the same name, but differing types in the possible matches list 42 with a 60% ranking. With respect to the matches that are accordingly ranked as 60%, if subsequent attempts to determine a suitable match fail, the same name module 56 will attempt to convert the input type to the output type, and if successful, adds the mapping to the matches list 40 with a 100% ranking.

If a match has not been obtained after execution of the predefined mapping module 52 and the same name module 56, then additional modules 58 are invoked. The additional modules 58 determine possible matches by examining portions of the input and output column attributes (which includes their types). For example, such modules match input and output column names based upon how similar the names are. The different name matching functionality may examine the names by comparing fragments of the columns' names with each other. A column's name may be broken up into fragments by seeking separators in the name. A separator may include the beginning of a name, the ending of a name, any non-alphanumeric character, the transition between a lowercase letter and an uppercase letter, the transition between an alphabetic character and a numeric character, etc. Each fragment in the output column's name is compared to each fragment in the input column's name to determine how closely the fragments resemble each other. The closer the resemblance the higher the ranking. If the ranking is above a preselected threshold, the column mapping is added to the possible matches list 42 along with its ranking.

Another type of functionality used by these additional modules 58 is to adjust the match ranking based upon the data type of the input and output columns. The more similar the types between the two columns, the higher the ranking. For example, an input column's data type that matches exactly the data type of the output column will increase the match ranking. The more that an input column's data type differs from the output column's data type the lower the match ranking. An input column that has a data type of real number will have its ranking adjusted down if the output column's data type is integer. The ranking is even lower if the input column's data type is text compared to the output column's data type of integer.

The modules 58 may determine rankings based upon similarity of data format (e.g., length) and content. For example, an input column that contains only “yes” or “no” responses will have a higher ranking if the output column also contains only “yes” or “no” responses. The ranking would be lower if the output column contained long text strings.

The modules 58 may on their own accord determine the types, formats, and content of the input and output columns by checking the data type and format/informat information, if available. Otherwise, it samples the data contained in the two columns to seek a pattern that will reveal its type, format, and content.

The modules 58 also may examine mappings previously generated in order to determine possible matches (as performed by previous mapping module 68). The previously generated mappings are searched to find an output column that has already been matched to an input column of the same name as the input column currently being searched. If the search is successful, then the current input column is mapped to the output column. The mapped column's data types are examined for compatibility. If the data types are not compatible, the mapping is placed in the possible matches list 42 with a 40% ranking. Otherwise, it is added to the matches list 40.

The column mapping module 38 achieves even greater efficiency by initially invoking less process intensive modules, such as the predefined mapping module 52. If these less intensive modules do not produce a suitable match, then the column mapping module 38 invokes the more intensive partial and different attribute matching modules 58. Also, performance is further enhanced by simultaneously executing two or more different matching processes. The multi-threaded processes may terminate when one of the other processes determines a suitable column match for an input column, or the ranking results of the multi-threaded processes may be pooled to yield an overall ranking. For example, if the process (that utilized the previous mapping technique) yields a high ranking score and the process (that mapped based upon data type) yields a low ranking score, the two scores can be combined into a composite score which is stored in the possible matches list 42 along with the mapping.

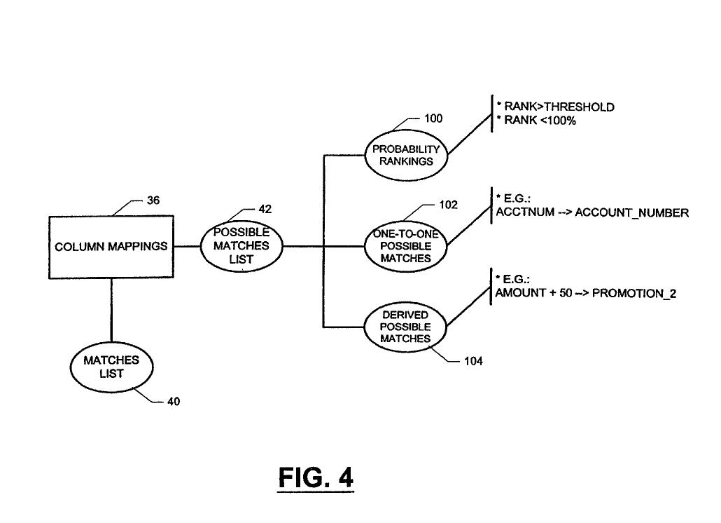

FIG. 4 depicts a data structure to store the column mappings 36. The column mappings 36 contain both the exact matches list 40 and the possible matches list 42. The matches list 40 maps which input columns exactly match which output columns. The possible matches list 42 associate probability rankings 100 with the matches. Optionally, only matches that satisfy a preselected threshold may be stored in the possible matches list 42.

The matches associated with the ranking probabilities may be one-to-one type matches 102 or derived type matches 104. For example, a one-to-one type match between the input column “ACCTNUM” and output column “ACCOUNT_NUMBER” may have an associated ranking of 70%. A derived type match may map the output column “PROMOTION_2” as being derived from sum of the input column “AMOUNT” and the constant fifty.

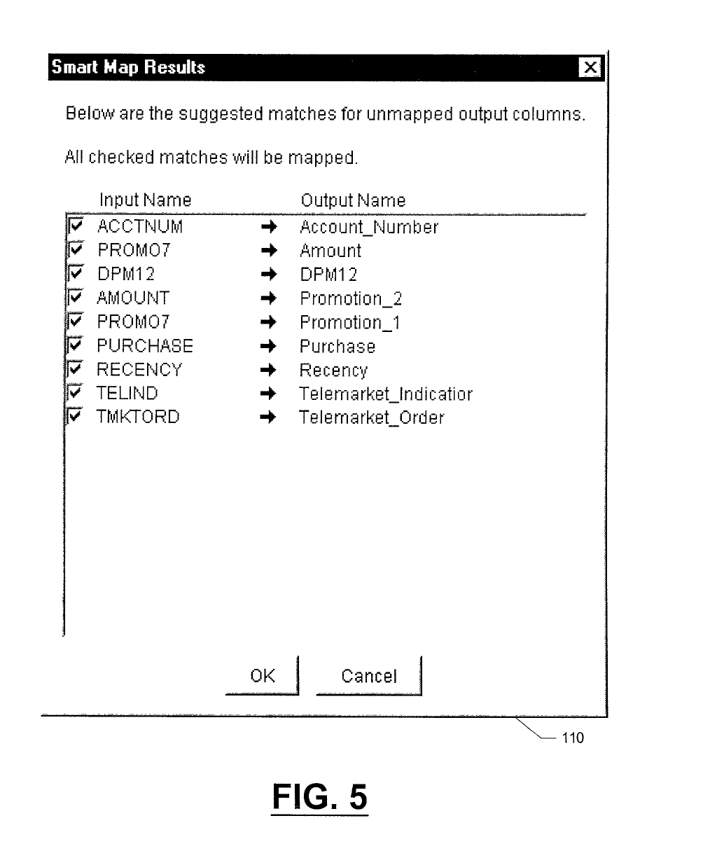

Various interfaces may be used to present the column mapping data. FIG. 5 depicts one type of interface at 110. Interface 110 allows the user to deselect the possible matches determined by the mapping system. The interface 110 may also indicate the ranking associated with each mapping to assist the user in assessing which mappings to retain.

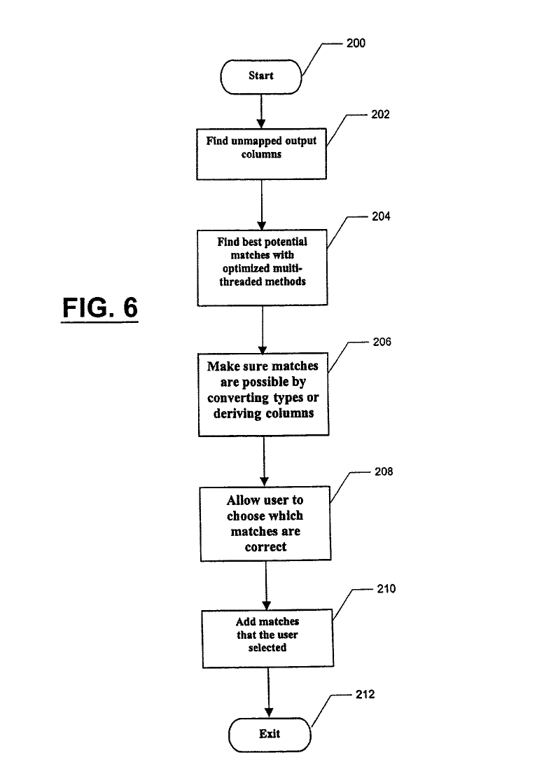

FIGS. 6-14 depict an example of structuring the execution of various mapping techniques. FIG. 6 depicts an overview of the mapping process. Start block 200 indicates that processing begins at block 202. In process block 202, unmapped output columns are identified. In process block 204, potential matches for the unmapped output columns are selected from among the available input columns using various mapping techniques. Verification that matches are possible by converting data types or deriving columns occurs in process block 206. Users select from the list of potential matches (as may be presented to the user by the interface of FIG. 5) which matches are to be mapped in process block 208. The user-selected matches are added to a matches list in process block 210. Processing concludes at exit block 212.

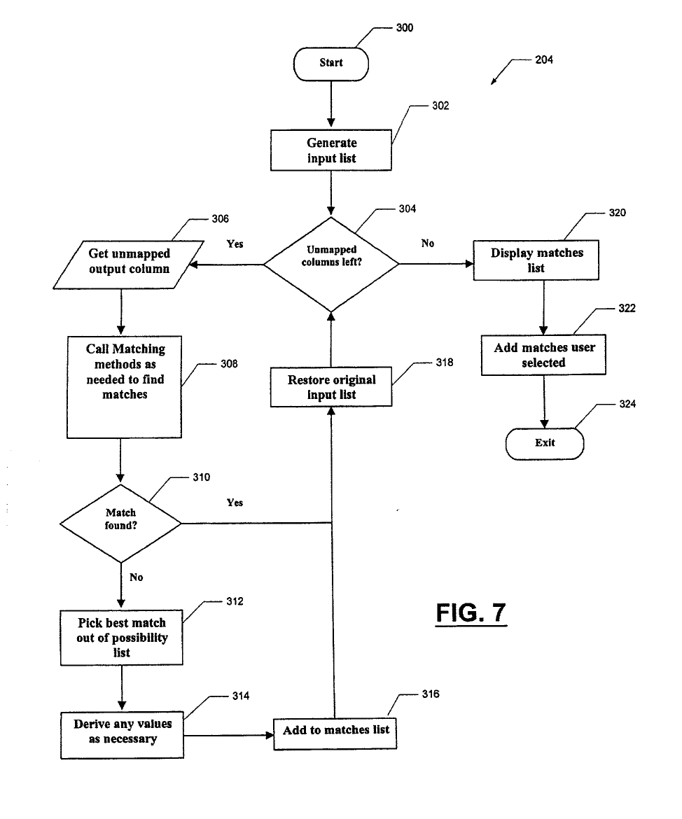

FIG. 7 depicts in greater detail the operation of process block 204 which finds the best possible matches with optimized multi-threaded techniques. With reference to FIG. 7, start block 300 indicates that processing begins at process block 302. A list of input columns is created at process block 302. At decision block 304, a check is performed to see if any output columns remain to be mapped. Because this is the first iteration through the process, output columns remain to be mapped and thus processing continues at process block 306.

At process block 306, an unmapped output column is obtained. At process block 308, potential matches for mapping are obtained through the use of various mapping techniques. At decision block 310, a check is performed to see if any absolute column matches have been found through use of one or more of the various mapping techniques. If no absolute matches have been found, processing continues at process block 312 where a match is selected from among those in a possible matches list. In process block 314, the derivation of any necessary values occurs. The identified match is added to the matches list at process block 316. The original input list is obtained at process block 318 and processing continues at decision block 304.

If more columns need to be mapped as determined at decision block 304, then processing continues at process block 306. If decision block 304 finds that there are no remaining unmapped columns, processing continues at process block 320. At process block 320, a list of found matches (if any) is presented to the user so that the user may select which columns are to be mapped from among the identified matches. At process block 322, any matches approved by the user at process block 320 are added to a list of matches for mapping. Processing concludes at exit block 324.

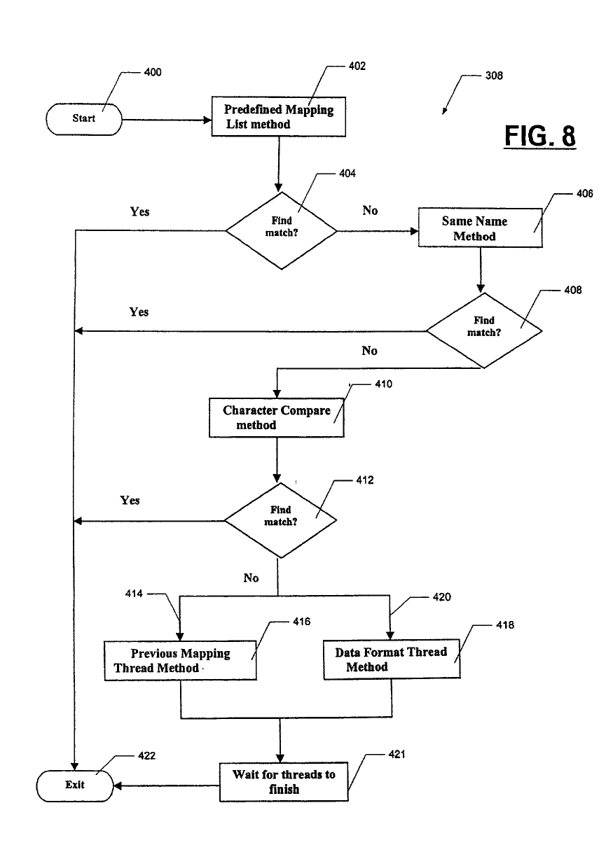

FIG. 8 depicts one example of structuring execution of the multiple mapping techniques to efficiently match columns. In this example, five mapping techniques are used: a predefined mapping list method (at process block 402); a same name method (at process block 406); a character compare method (at process block 410); a previous mapping thread method (at process block 416); and a data format thread method (at process block 418). In this example, processing stops if one of the mapping techniques locates one or more suitable matches. However, it should be understood that many different execution configurations exist for the use of the multiple mapping techniques. For example, the user may indicate that one or more of the mapping techniques should not be used. As another example, multiple mapping techniques may execute concurrently as threads which terminate the process of the other if a suitable match is found.

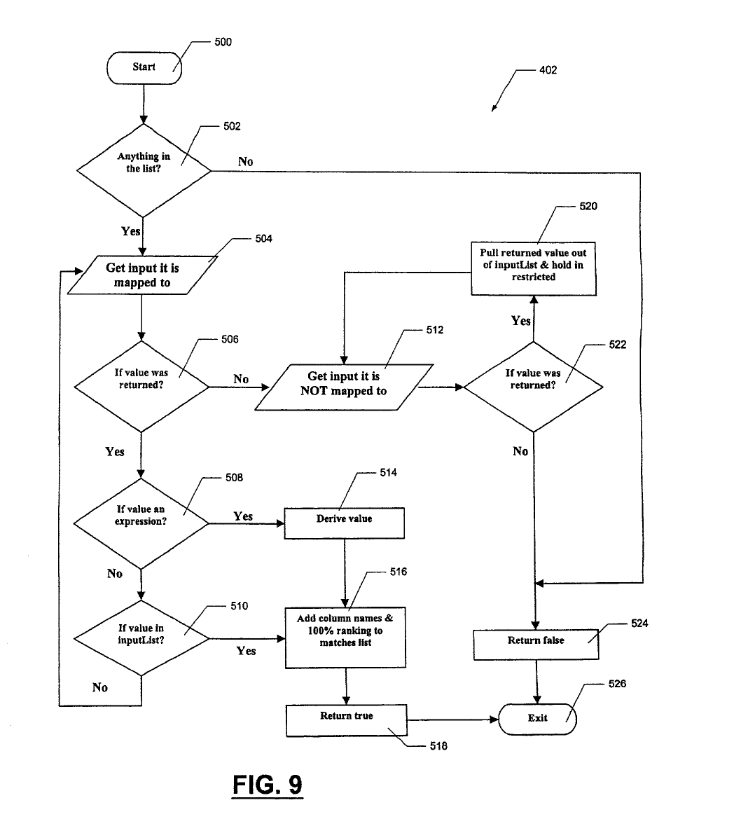

With reference to FIG. 8, start block 400 indicates that processing begins at process block 402. At process block 402, any mappings defined by the user are used to identify column matches (FIG. 9 describes in greater detail the processing of this method). Decision block 404 determines whether any matching columns were found through the predefined mapping list method. If suitable matches were located, processing concludes at exit block 424.

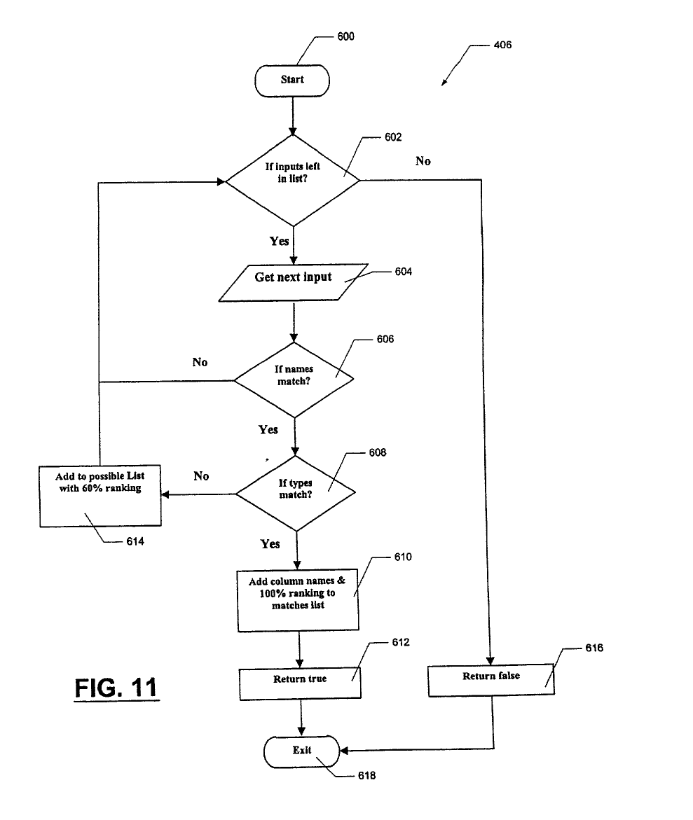

If suitable matches were not located, processing continues at process block 406 where the same name method is invoked to attempt to identify matching columns. This method examines the name of an input column with the name of the output column. If the names exactly match, then the two columns are identified as a match (FIG. 11 describes in greater detail the processing of this method). Decision block 408 examines whether a matching column was found through this method. If a match was found, processing concludes at exit block 424.

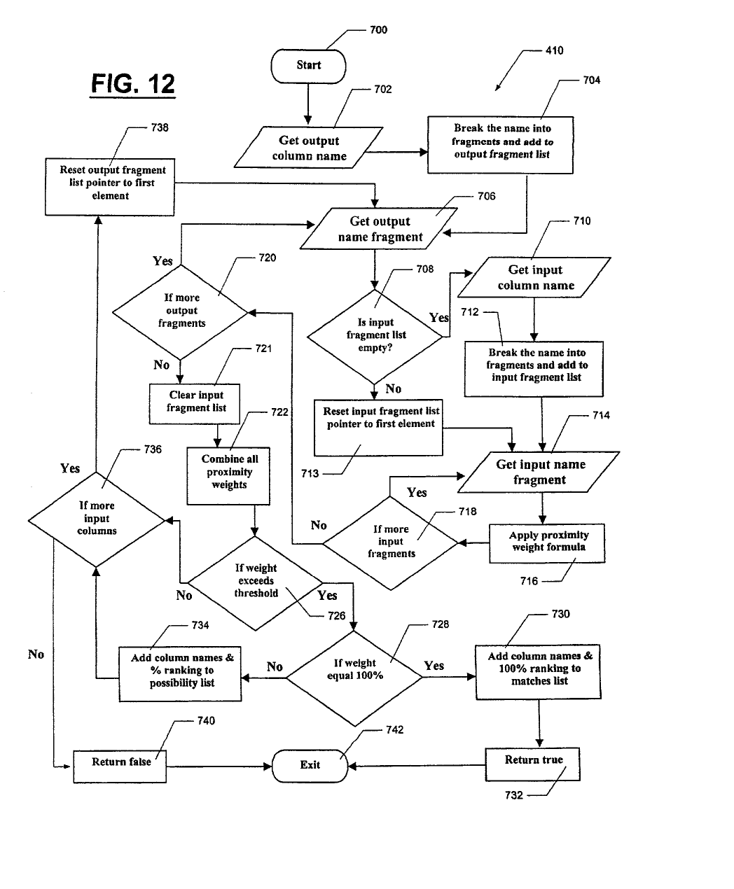

If a suitable match was not found, processing continues at process block 410 where the character compare method is invoked to attempt to identify potential column matches. This method compares portions of the columns' names (e.g., name fragments) with each other to identify possible matches (FIG. 12 describes in greater detail the processing of this method). Decision block 412 determines whether any matches were located. If matches were found, processing concludes at exit block 424.

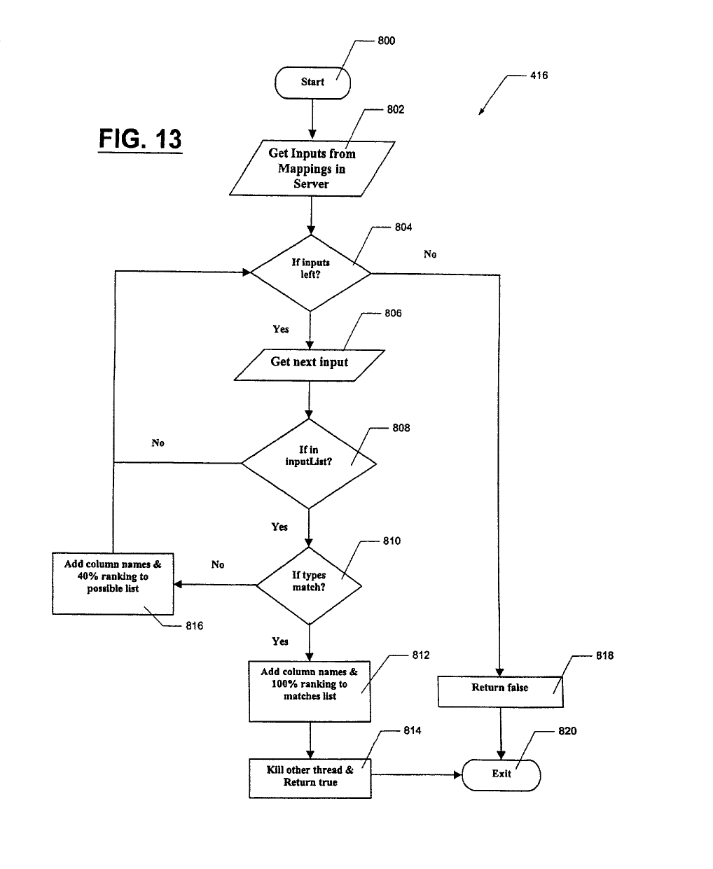

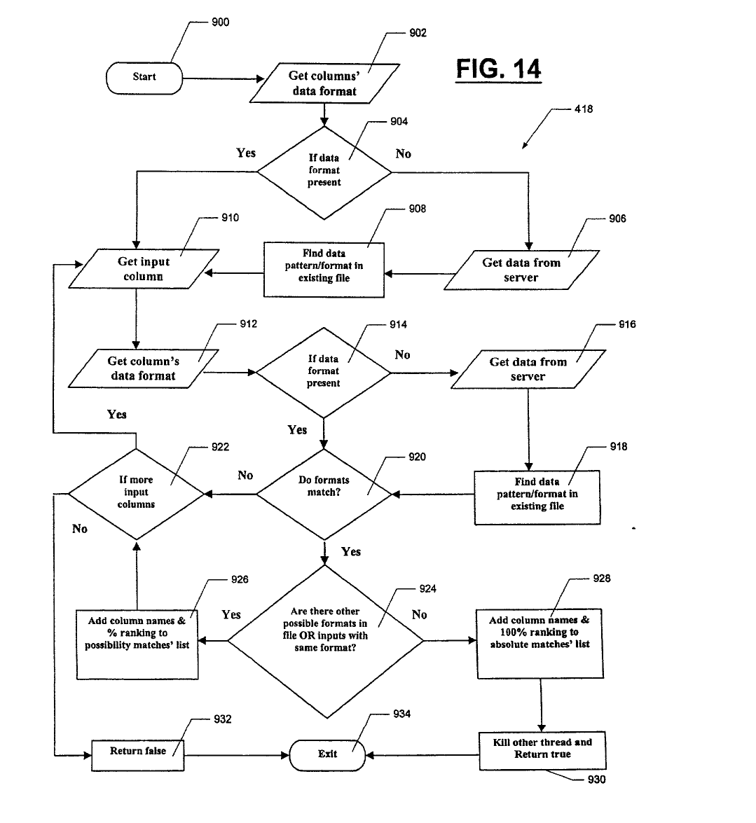

If no matches were located, processing continues at the concurrent processing branches 414 and 420. Concurrent processing branches 414 and 420 indicate that process blocks 416 and 418 execute concurrently. At process block 416, the previous mapping method is invoked to identify potential column matches. In this method, previously generated mappings are searched to find an output column that has already been matched to an input column of the same name as the input column currently being searched (FIG. 13 describes in greater detail the processing of this method). At process block 418 the data format method is invoked to identify potential matches. Rankings are determined based upon similarity of data format (e.g., length) and content. (FIG. 14 describes in greater detail the processing of this method). If one of the threads finds a match, then the other thread is terminated. Process block 421 waits until the threads have completed. Matches are then available for review by the user. Processing completes at exit block 422.

FIG. 9 depicts the operation of a predefined mapping list method 402. The user supplies a predefined mapping list. Each output column in the list may have multiple input columns mapped to it. Additionally, each input column may be mapped to multiple output columns. Start block 500 indicates that decision block 502 is first processed. Decision block 502 examines this list for the output column that is currently being processed to see if it is associated with any input columns. If no output columns are found in the list by decision block 502, then process block 524 returns an indicator that no matches were found before it terminates at exit block 526. However, if the list does contain output columns that have been mapped to input columns, then process block 504 retrieves the first input column the list says it is mapped to. The list identifies if this input column was from a one-to-one mapping or a derived mapping. If the input column was from a derived mapping, we know that it is an expression and it is assumed to be correct.

When decision block 508 has determined that the mapping is dealing with a derived mapping, control passes to process block 514. Process block 514 derives the value before control passes to process block 516. Process block 516 adds the input column and output column mapping to the matches list with a 100% ranking. Process block 518 returns an indicator that a match has been found before processing for this method concludes at exit block 526.

However, if decision block 508 determines that it is not an expression, then decision block 510 examines whether the value is in the input list. If the input column was from a one-to-one mapping, decision block 510 checks to see if this input column is in the input list. If the returned input column is in the input list, process block 516 adds the pair to the matches list with a 100% ranking. Otherwise, decision block 510 determines that it is not an input column that is available for use so the list is checked again at process block 504 for other input columns to which the output column can be mapped.

If decision block 506 had originally determined that no match was found for the output column, then process block 512 checks the list again to see if there are any input columns the user does not want that output column to be mapped to. If decision block 522 determines that that case is true, the returned input columns are temporarily pulled out of the input list by process block 520 and held in a restricted list so that subsequently executed mapping methods do not attempt to map them together. They are restored to the input list after all attempts to find a match have been exhausted by subsequent mapping methods. If no more “non-mapping indicators” are in the list, then processing terminates at exit block 526.

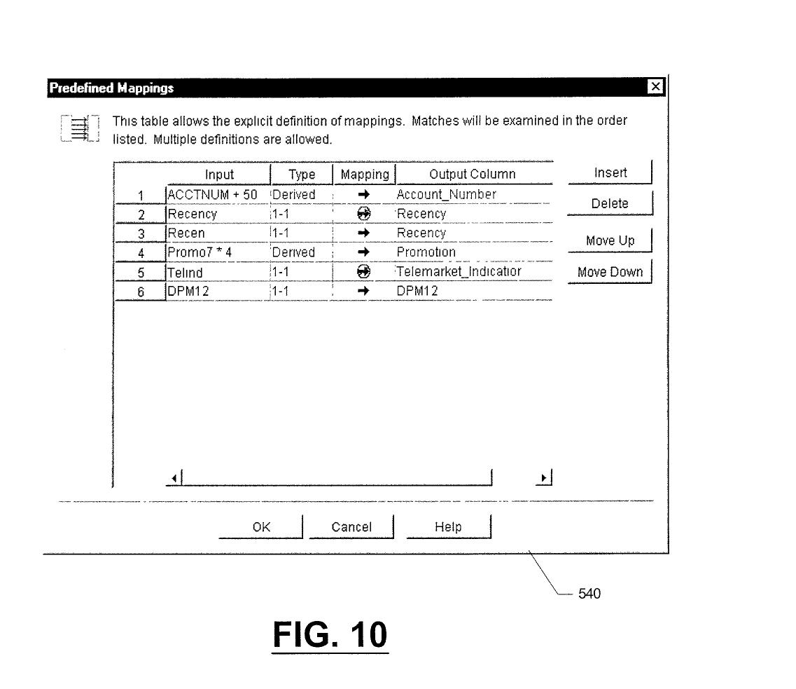

FIG. 10 depicts an interface 540 by which a user can select which input columns map to which output columns. The “Type” column in interface 540 allows the user to specify whether a mapping is one-to-one or derived. The “Mapping” column allows the user to specify whether an input column is not to be mapped to an output column. For example, the “Recency” input column is specified not to be mapped to the “Recency” output column.

Suppose the predefined list in interface 540 resembled:

| | |
|---|---|
| MLX → Multi_Expression | 1-1 |
| Seven → ConstantDays | 1-1 |
| Five → ConstantDays | 1-1 |
| Temp − Current → Status | Derived |
| Static ?→ Stat | 1-1 |

The input list includes the following.

MLX
Five
Static

The Multi_Expression output column is matched to the MLX input column. The input column is one-to-one and in the input list so the pair is added to the matches list with a 100% ranking. Another match in the list links the ConstantDays output column to the Seven input column. The input column is one-to-one but not in the input list. The mapping method looks for the next input and finds Five. The input column is one-to-one and in the input list. The pair is added to the matches list with 100% ranking.

The list matches the “Status” output column to the input column “Temp—Current”. The input column is derived so the expression will be created. The pair is added to the matches list with a 100% ranking. The Stat output column does not have a match in the list. But it is not supposed to be mapped to the Static input column. Static is in the input list so it is pulled out of the input list and held in the restricted list until after a match for Status output column is found.

FIG. 11 depicts the operation of a same name mapping method 406. Start block 600 indicates that processing begins at decision block 602. At decision block 602 a check is performed to determine whether there are any input columns in the input list to be processed. If there are none, then process block 616 returns an indicator that no matches were achieved. However, if there are inputs in the input list to be processed, then process block 604 retrieves an input from the list. Decision block 606 checks to see if the names of the input and output columns match. If there is a match, then decision block 608 checks whether the data types for the input and output columns match. If the data types do not match, the column names are added to the possible matches list with a 60% ranking. Processing then continues at decision block 602 where the next input is processed. It is noted that in the same name mapping method or in any mapping method different probability values may be used to suit the application at hand. One skilled in the art may also use any match ranking system that conveys uncertainty or use different uncertainty probability. For example, a boolean match ranking system may indicate either that the mapping is with complete certainty or with less than complete certainty, or may use a tiered system that conveys whether the mapping is with complete certainty, above average certainty, average certainty, or below average certainty.

However, if the data types did match, then process block 610 adds the column names to the matches list along with a 100% ranking. Process block 612 returns a successful match indicator before processing returns to the main routine at exit block 618.

It is further noted that if subsequent mapping methods do not find a better match (e.g., via the character compare mapping method of FIG. 12), the same name mapping method will later attempt to convert the input type and if successful, it will be added to the matches list.

As an example of the same name mapping method, consider an input list that includes the following:

| NAME | TYPE |
|---|---|
| Count | Double |
| Arrival | Double |

In this example, the unmapped output columns are the following:

| NAME | TYPE |
|---|---|
| Count | Double |
| Arrival | Char |

The input and output columns named “Count” have the same data type of Double. The same name mapping method will add these columns to the matches list with a 100% ranking. The input and output columns named “Arrival” have differing data types and are added to the possible matches list with a 60% ranking.

FIG. 12 depicts the operation of a character comparison method 410. The method obtains an unmapped output column's name and breaks it into fragments by seeking separators in the name. A separator may include the beginning of a name, the ending of a name, any non-alphanumeric character, the transition between a lowercase letter and an uppercase letter, or the transition between an alphabetic character and a numeric character. Separators may not be included as fragments or as part of the fragment. For each input column name in the input list, the column's name is broken into fragments as well. Each fragment in the output column's name is compared to each fragment in the input column's name by applying a proximity weighting formula. This formula takes into consideration the position of the fragment in the name as well as the offset of a character in question with respect to its proximity to other characters that match in the other fragment being considered. The operation is described in more detail as follows.

Start block 700 indicates that processing begins at process block 702 where an unmapped output column name is obtained. Process block 704 examines each character in the output column's name to find a separator, in order to break the name into fragments. An output fragment list is created and each of the fragments are added to the list. Also, an input fragment list is created where the input fragments will be stored. Process block 706 obtains an output name fragment from the output fragment list.

Decision block 708 checks if the input fragment list has any elements. If the list is empty, then process block 713 resets the input fragment list pointer to the first element. However, if the list is not empty, then process block 710 obtains an input column name. Process block 712 examines each character in the input column's name to find a separator, in order to break the name into fragments. Process block 714 obtains one of the input name fragments to compare it with the output column fragments. To make the comparison, process block 716 performs uses a proximity weight formula. The proximity weight formula is based upon a character comparison between the output name fragment and the input name fragment. Exemplary factors the proximity weight formula may use include: the position of the fragment in its list, the positions of the characters being compared at any one time, and also how the characters in a fragment relate to one another with emphasis on the first character and with respect to the other fragment's characters.

To compute the proximity weight formula, we begin by defining the following entities:

L: the length of the longer fragment;

N: the number of characters in the shorter fragment that exist in the longer fragment;

S: the length of the longest sub-string in the shorter fragment that exists in the longer fragment;

C: a chosen constant that represents the likelihood of a maximum number of possible fragments in a name;

P: the difference between the constant C and the absolute difference between the individual fragments' position in the name;

M: a flag value as to whether the first characters match in both fragments;

CW, SW, PW, FW: chosen weights/factors used in the proximity weight formula. These are based on the analysis of how the weights affect the final result; and

T: the threshold.

The constant, C, may be chosen to be 5, because the probability of finding a name with more than five fragments is minimal. The weight formula has a maximum result value equal to 1. Thus, the weights add up to 1 and the fractional portions affect each of the weights. The count weight, CW, may be 0.25, and is affected by the count of characters in the shorter fragment that match in the longer fragment. The sub-string weight, SW, may be 0.5, and is affected by the length of the longest sub-string in the shorter fragment that exists in the longer fragment. The positional weight, PW, is 0.15, and is affected by the position of the fragments in their names. Lastly, the first character weight, FW, is 0.1, and is affected if the first characters in the fragments match. With the variables and constants defined, the proximity weight formula may resemble:

Proximity Weight Formula: CW*(N/L)+SW*(S/L)+PW*(P/C)+FW*M

The proximity weights for each fragment combination is summed up to give a total weight for the output name/input name combination. If the average of these weights exceeds the threshold, chosen to be 0.3, then the output name and the input name are considered as potential matches.

Decision block 718 ensures that the proximity weight formula is applied to all input fragments. Decision block 720 passes control to process block 706 if more output fragments need to be compared to the input fragments. If the output fragments have been processed, then process block 721 clears the input fragment list. At process block 722, the proximity weights for each fragment combination are summed to generate a total weight for the output name/input name combination. If decision block 726 determines that this total weight exceeds the threshold, chosen in this example to be 1, then the output name and the input name are considered as potential matches and stored in the possible matches list before processing continues at decision block 736. However, if this total weight does exceed the threshold, then decision block 728 examines whether the total weight equals 100%. If the total weight does equal 100%, then process block 730 adds the output column name/input column name pair to the matches list. Process block 732 returns an indicator that a match has been located. Processing returns to the main routine at exit block 742.

However, if the total weight does not equal 100% as determined by decision block 728, then process block 734 adds the output column name/input column name pair to the possibility matches list. If decision block 736 determines that additional input columns need to be processed, then process block 738 resets the output fragment list pointer to the first element so that the remaining input columns can be compared to the output column name. If decision block 736 determines that there are not any additional input columns to be processed, then process block 740 returns an indicator that an exact match has not been located. Processing returns to the main routine at exit block 742.

The following is an example of comparing input and output column name fragments using the proximity weight formula. Consider the input list as follows:

NAME
Account_Number
EmployeeNumber

Suppose in this example the unmapped output column's name is ‘AcctNum’. Initially, we get the output column name, ‘AcctNum’. Breaking the name into fragments, we notice a transition between t and N, and thus we end up with ‘Acct’ and ‘Num’ in our output fragment list. We proceed to get the first output fragment, ‘Acct’. The input fragment list is empty, so we get the first input name, ‘Account Number’. Breaking it apart, we find the separator, _, and thus we end up with ‘Account’ and ‘Number’ in our input fragment list. It is also noted that a dictionary of words and fragments may be used to identify the fragments in a column's name.

Our first input fragment name is ‘Account’ and so we apply the proximity weight formula. Processing ‘Acct’ and ‘Account’, we compute the numeric entities as follows:

| Description | Entity | Value |
|---|---|---|
| Length of longer fragment, ‘Account’ | L | 7 |
| Number of characters in ‘Acct’ existing in ‘Account’ | N | 4 |
| Length of longest sub-string in ‘Acct’ existing in | S | 3 |
| ‘Account’ | | |
| Probability constant | C | 5 |
| Position of ‘Acct’ in ‘AcctNum’ is 1, and position | P | 5 |
| of ‘Account’ in ‘Account_Number’ is 1, | | |
| thus positional difference is 5-\|1-1\| | | |
| First characters in fragments DO match | M | 1 |

The proximity weight formula calculation for the output is as follows:

Proximity Weight Value: 0.25(4/7)+0.5(3/7)+0.15(5/5)+0.1(1)=0.607

Processing ‘Acct’ and ‘Number’, we compute the numeric entities as follows:

| Description | Entity | Value |
|---|---|---|
| Length of longer fragment, ‘Number’ | L | 6 |
| Number of characters in ‘Acct’ existing in ‘Number’ | N | 0 |
| Length of longest sub-string in ‘Acct’ existing in | S | 0 |
| ‘Number’ | | |
| Probability constant | C | 5 |
| Position of ‘Acct’ in ‘AcctNum’ is 1, and position | P | 4 |
| of ‘Number’ in ‘Account_Number’ is 2, | | |
| thus positional difference is 5-\|1-2\| | | |
| First characters in fragments DO NOT match | M | 0 |

The proximity weight value for these entities is as follows:

Proximity Weight Value: 0.25(0/6)+0.5(0/6)+0.15(4/5)+0.1(0)=0.120

There are no more input fragments, so we check for more output fragments. We retrieve the next output fragment, ‘Num’, and check if our input fragment list is empty. We reset the input fragment list pointer back to the first element and get the input fragment name ‘Account’, thereby processing the next pair. Processing ‘Num’ and ‘Account’, we compute the numeric entities as follows:

| Description | Entity | Value |
|---|---|---|
| Length of longer fragment, ‘Account’ | L | 7 |
| Number of characters in ‘Num’ existing in ‘Account’ | N | 1 |
| Length of longest sub-string in ‘Num’ existing in | S | 1 |
| ‘Account’ | | |
| Probability constant | C | 5 |
| Position of ‘Num’ in ‘AcctNum’ is 2, and position of | P | 4 |
| ‘Account’ in ‘Account_Number’ is 1, | | |
| thus positional difference is 5-\|2-1\| | | |
| First characters in fragments DO NOT match | M | 0 |

The proximity weight value for these entities is as follows:

Proximity Weight Value: 0.25(1/7)+0.5(1/7)+0.15(4/5)+0.1(0)=0.227

The next input fragment is ‘Number’, and we process the next combination. Processing ‘Num’ and ‘Number’, we compute the numeric entities as follows:

| Description | Entity | Value |
|---|---|---|
| Length of longer fragment, ‘Number’ | L | 6 |
| Number of characters in ‘Num’ existing in ‘Number’ | N | 3 |
| Length of longest sub-string in ‘Num’ existing in | S | 3 |
| ‘Number’ | | |
| Probability constant | C | 5 |
| Position of ‘Num’ in ‘AcctNum’ is 2, and position of | P | 5 |
| ‘Number’ in ‘Account_Number’ is 2, | | |
| thus positional difference is 5-\|2-2\| | | |
| First characters in fragments DO match | M | 1 |

The proximity weight value for these entities is as follows:

Proximity Weight Value: 0.25(3/6)+0.5(3/6)+0.15(5/5)+0.1(1)=0.625

At this point, there are no more input fragments, so we check for more output fragments. Our output fragment list pointer is pointing to the last element, so we clear the input fragment list and combine the proximity weights as follows:

For the Total Weight for ‘AcctNum’ and ‘Account_Number’ combination:

0.607+0.120+0.227+0.625=1.579

Percentage ranking: 1.579/4=39.48%

The value 0.3948 exceeds the threshold of 0.3, so the output name and input name pair are added to the possible matches list. We find more input columns and so we reset the output fragment list pointer to point back to the first element in the output fragment list. We get the fragment name, ‘Acct’. The input fragment list is empty, so we get the input column name of ‘EmployeeNumber’. Breaking the name into fragments, we notice a transition between e and N, giving us two fragments, ‘Employee’ and ‘Number’. Retrieving the first input fragment name, ‘Employee’, we apply the proximity weight formula. Processing ‘Acct’ and ‘Employee’, we compute the numeric entities as follows:

| Description | Entity | Value |
|---|---|---|
| Length of longer fragment, ‘Employee’ | L | 8 |
| Number of characters in ‘Acct’ existing in ‘Employee’ | N | 0 |
| Length of longest sub-string in ‘Acct’ existing in | S | 0 |
| ‘Employee’ | | |
| Probability constant | C | 5 |
| Position of ‘Acct’ in ‘AcctNum’ is 1, and position | P | 5 |
| of ‘Employee’ in ‘EmployeeNumber’ is 1, | | |
| thus positional difference is 5-\|1-1\| | | |
| First characters in fragments DO NOT match | M | 0 |

The proximity weight value for these entities is as follows:

Proximity Weight Value: 0.25(0/8)+0.5(0/8)+0.15(5/5)+0.1(0)=0.150

Our next pair is ‘Acct’ and ‘Number’, which was processed earlier to give a weight of 0.120. The following output fragment is ‘Num’, and so we pair it with ‘Employee’ and ‘Number’ respectively. Processing ‘Num’ and ‘Employee’, we compute the numeric entities as follows:

| Description | Entity | Value |
|---|---|---|
| Length of longer fragment, ‘Employee’ | L | 8 |
| Number of characters in ‘Num’ existing in ‘Employee’ | N | 1 |
| Length of longest sub-string in ‘Num’ existing in | S | 1 |
| ‘Employee’ | | |
| Probability constant | C | 5 |
| Position of ‘Num’ in ‘AcctNum’ is 2, and position of | P | 4 |
| ‘Employee’ in ‘EmployeeNumber’ is 1, | | |
| thus positional difference is 5-\|2-1\| | | |
| First characters in fragments DO NOT match | M | 0 |

The proximity weight value for these entities is as follows:

Proximity Weight Value: 0.25(1/8)+0.5(1/8)+0.15(4/5)+0.1(0)=0.214

Our next pair of ‘Num’ and ‘Number’, which was processed earlier, gives us a weight of 0.625. At this point, there are no more input fragments, so we check for more output fragments. Our output fragment list pointer is pointing to the last element, so we clear the input fragment list and combine the proximity weights as follows:

Total Weight for ‘AcctNum’ and ‘EmployeeNumber’ combination:

0.150+0.120+0.214+0.625=1.109

Percentage ranking: 1.109/4=27.73%

The value 0.2773 does not exceed the threshold of 0.3, so the output name and input name pair are not added to a possibility matches' list. The output name and input name pair are added to a possibility matches' list. We find no more input columns, so we return false and exit. The resulting possible matches list is as follows:

| INPUT COLUMN NAME | OUTPUT COLUMN NAME | RANKING |
|---|---|---|
| Account_Number | AcctNum | 39.48% |

If the character compare mapping method does not yield a suitable match, then additional mapping methods are used (e.g., the previous mapping thread method and the data format thread method). To enhance performance, the additional mapping methods are executed in parallel, and if one mapping method locates a suitable match, then the execution of the other method is terminated.

FIG. 13 depicts the operation of a previous mapping thread method 416. Start block 800 indicates that processing begins at process block 802 where a list of inputs from existing mappings for the current output column are obtained from a server (or other data source). If decision block 804 determines that inputs from the mappings in the server need to be processed, then process block 806 retrieves a server input for processing. Decision block 808 examines whether the current server input is found in the input list that contains columns to be matched. If it is not, then processing returns to decision block 804 to process additional server inputs. However, if the current server input is found in the input list, then decision block 810 examines whether the types match between the server input and the column from the input list. If the types do not match, then at process block 816 the mapping is placed in the possible list with a reduced ranking (e.g., 40%). Processing continues at decision block 804 to process any remaining server inputs. However, if the types do match as determined by decision block 810, then process block 812 adds the column names to the matches list along with a 100% ranking. With an exact match found, process block 814 terminates the other thread and returns an indicator that an exact match has been found. Processing returns to the main routine at exit block 820.

The following is an example of the previous mapping thread method. Column mappings in other mappings from the server may include the following:

| OUTPUT NAME | INPUT NAME | TYPE |
|---|---|---|
| _LOADTM | Current_TimeStamp | TimeStamp |
| TodayTime | tTime | TimeStamp |
| TodayTime | TexasTime | TimeStamp |

The following are the output columns (contained in the input list) for which we are looking for matches:

| NAME | TYPE |
|---|---|
| _LOADTM | TimeStamp |
| TodayTime | Time |

In the previously defined mappings for this example, there is an instance of _LOADTM being mapped to Current_TimeStamp. The types match so we add it to the matches list with 100% ranking. The first input column we find for the TodayTime output column is tTime, but the types do not match. The pair is added to the possible list with a 40% ranking and this mapping method looks at the next input it found from the other mappings.

Operating in parallel with the previous mapping thread is a data format mapping method 418. This method 418 examines the data type, length and format/informat information in order to map output columns to input columns. With reference to FIG. 14, start block 900 indicates that processing begins at process block 902. In process block 902, the unmapped output columns' data format is obtained. This format may be an integer format, a text format, a YESNO format, or any other type of format, such as even a user-defined format. Decision block 904 determines whether the unmapped output column's data format is present. If it is not, then process block 906 obtains the unmapped output column's data from the server. Process block 908 finds a pattern in the data to reveal its format. It is mapped to an existing file containing various data formats. If the pattern is unique, it is appended to the file. Processing then continues at process block 910.

However, if the check performed at decision block 904 indicates that a data format is present, process block 910 obtains the input column's data format so that its format may be compared to the unmapped output column's format. The higher the degree of similarity between the two formats, the higher the ranking of the mapping. Process block 912 retrieves the input column's data format. In similar fashion to the unmapped output column's format determination, decision block 914 uses the input column's data to determine the format if the format is not present. Process blocks 916 and 918 perform this functionality, and processing continues at decision block 920. However, if the data format was present as determined by decision block 914, then processing continues at decision block 920.

Decision block 920 checks whether the data formats of the unmapped output column and the input column match. If they do not match, then for purposes of this matching method, a match does not exist between the two columns. Accordingly, decision block 922 passes control to process block 910 to compare additional input columns that remain. If no more input columns remain to be processed, then process block 932 returns a no match indicator before control passes back to the main routine at exit block 934.

However, if decision block 920 determines that the data formats of the unmapped output column and the input column do match, then decision block 924 examines whether there are other possible formats in the file or inputs with the same format. The absence of other possible formats significantly increases the probability that these two columns are a match. Accordingly, the match is added at process block 928 to the matches list with a 100% ranking, and process block 930 terminates the other mapping method thread and returns a match located indicator. Processing returns to the main routine via exit block 934.

If decision block 924 had determined that other formats were possible, then process block 926 adds the column names to the possibility matches list along with a percentage ranking. To compute the percentage rankings, we determine the fraction of the output column being processed to the number of input columns that are possible matches. Thus, if there is only one possible match, the fraction is 1/1, thus giving a definite ranking of 100% on the input column. If there is more than one possible match, the fraction is 1/number of possible matches, thus giving a proportionate ranking of less than 100% on each of the input columns. In the case where we go to the server to retrieve the columns' data and attempt to ascertain its format, we may determine that there could be more than one possible match in the file of formats. We thereby take the number of possible matches in the file, and add it to the number of possible matches in the input list. Hence, the fraction is 1/number of possible matches in the file plus the number of possible matches in the input columns list, thus giving a proportionate ranking again of less than 100% on the input column. After process block 926 computes the ranking and adds the columns to the possibility matches list, control passes to decision block 922 to analyze any additional input columns. After any additional input columns have been processed, processing returns to the main routine via exit block 934.

The following is an example of the data format mapping method. Consider the input list as follows:

| | | | | |
|---|---|---|---|---|
| NAME | TYPE | LENGTH | FORMAT | INFORMAT |

| | | | |
|---|---|---|---|
| DISHES | N | 8 | |
| PURCHASE | N | 8 | YESNO. |
| APPAREL | N | 8 | BEST12. |
| HEAT | N | 8 | HEATFMT. |
| ORIGIN | N | 8 | ORIGFMT. |
| SNGLMOM | N | 8 | YESNO. |

Suppose the unmapped output column has the following attributes:

| NAME | TYPE | LENGTH | FORMAT | INFORMAT |
|---|---|---|---|---|
| PROCUREMENT | N | 8 | YESNO. | |

Initially, we get the following output column's data attributes: numeric type, length of 8, and a format of YESNO. The data format is available, so we proceed to get the first input column. DISHES is of numeric data type, has a length of 8 with no format information. The informat column (which is not specified in this example) indicates how raw data is to be read so that variable values may be created. We therefore go to the server and get DISHES's data. Supposing DISHES's data comprises one digit and PROCUREMENT's data consists of one digit also, all the attributes match, and the actual data format match. We then determine a possible format from the existing file of formats, which will now match the format YESNO. Alternatively, suppose we find two other formats that match the data, say “formats 1.” and “BEST2”. This information is tied onto the column as we leave the file of formats. We now check to see if there are other input columns with the same format and notice that PURCHASE and SNGLMOM have the same format. Computing the ranking, we find that the proportionate fraction is 1/5, and ultimately we add the input column DISHES and the output column PROCUREMENT to the possible list, along with the percentage ranking.

We seek the next input column, PURCHASE. Its type, length and format match PROCUREMENT's attributes. We again observe that there is another input column with the same format as PROCUREMENT, that is, DISHES and SNGLMOM. The computed fraction is 1/3 and we add this next match to the possible list.

For the next three input columns, we notice conflicting formats with that of PROCUREMENT, thus we continue processing from the input list. Finally, SNGLMOM's attributes match that of PROCUREMENT, and the pair is added to the matches list with a computed fraction of 1/3. At this juncture, there are no more input columns to process, so we return false and exit. The resulting possible matches list is as follows:

| INPUT COLUMN NAME | OUTPUT COLUMN NAME | RANKING |
|---|---|---|
| DISHES | PROCUREMENT | 20.00% |
| PURCHASE | PROCUREMENT | 33.33% |
| SNGLMOM | PROCUREMENT | 33.33% |

As another example, consider an input list as follows:

| NAME | TYPE | LENGTH | FORMAT | INFORMAT |
|---|---|---|---|---|
| STARTDY | N | 8 | DATE9. | |
| APRTMNT | C | 1 | $YESNO. | |
| EDLEVEL | N | 8 | EDFMT. | |
| STATECOD | C | 2 | | |
| _SEGMNT_{—} | N | 8 | 6. | |
| ACCTNUM | N | 8 | BEST12. | BEST32. |

Suppose the unmapped output column has the following attributes:

| | | | | |
|---|---|---|---|---|
| NAME | TYPE | LENGTH | FORMAT | INFORMAT |

| | | | |
|---|---|---|---|
| EDUC_LEVEL | N | 8 | EDFMT. |

We begin by determining the output column's data attributes. EDUC_LEVEL is of numeric type, has a length of 8, and the format is EDFMT. The data format is present thus we get the first input column. STARTDY is of numeric type, has a length of 8, but the format is DATE9. This conflicts with EDUC_LEVEL's data format, so we proceed with the next input column.

APRTMNT is of character type, and this conflicts with EDUC_LEVEL's data type. The next input column is EDLEVEL. It is numeric, has a length of 8, and the format is EDFMT. This matches EDUC_LEVEL. We then seek any other input columns with the same format, but to no avail. So the computed ranking fraction is 1/1. At this stage, we add the pair to the matches list. We return true and exit. Our matches list ends up as follows:

| INPUT COLUMN NAME | OUTPUT COLUMN NAME | RANKING |
|---|---|---|
| EDLEVEL | EDUC_LEVEL | 100.00% |

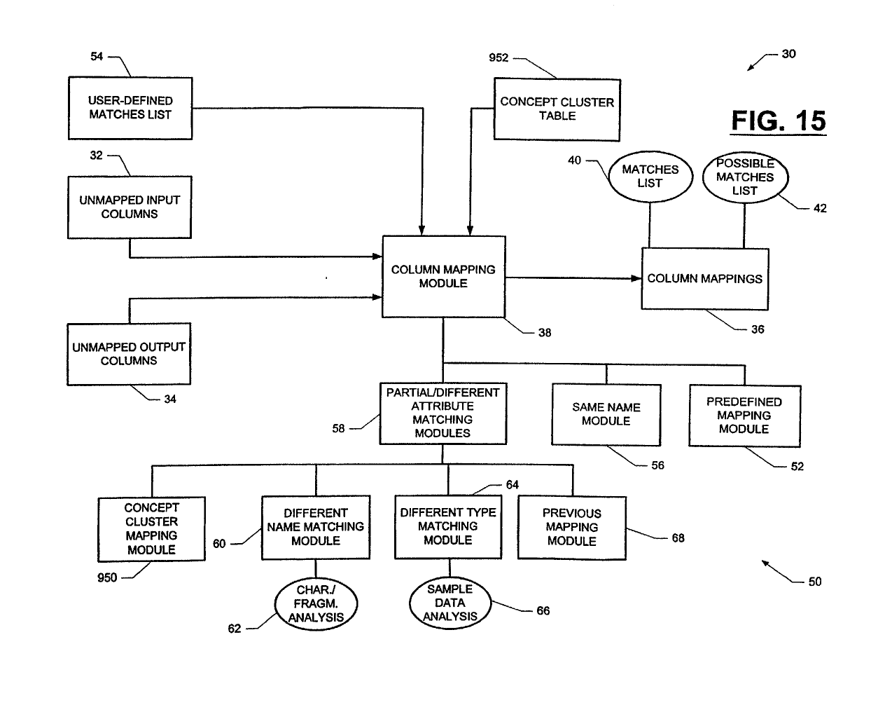

The embodiments described above are examples of structures, systems and methods having elements corresponding to the elements of the present invention recited in the claims. This written description enables those skilled in the art to make and use embodiments having alternative elements that likewise correspond to the elements of the invention recited in the claims. The intended scope of the invention may thus include other structures, systems or methods that do not differ from the literal language of the claims, and may further include other structures, systems or methods with insubstantial differences from the literal language of the claims. As an illustration, FIG. 15 depicts the mapping system including yet another partial/different attribute mapping method. While the different name matching module 60 may examine fragments of input and output columns for character similarity, a concept cluster module 950 examines the fragments to reveal whether two fragments are directed to the same or similar concept despite having an appreciable character difference. For example, an input column name that is “TIMESTAMP” has a different character profile than “DATESTAMP”. However, conceptually the two names are very similar as both the fragment “TIME” and fragment “DATE” are related. The more conceptually interrelated the fragments, the higher the ranking for the mapping between the two columns is. A concept cluster data table 952 may used by the concept cluster mapping module 950 to interrelate concepts, such as the temporal concepts of TIME and DATE. The table 952 may also include a metric as to how interrelated concepts are. The computed ranking from the concept cluster mapping module 950 may be used alone or in combination with rankings from other mapping modules to determine how good a match exists between two columns. It is to be understood that the mapping methods described above apply to many different types of columns, including columns that contain pictures and other non-numeric and non-character based information.

It is claimed:

1. A computer-implemented method for mapping an input column to an output column, said input column and said output column having attributes, comprising the steps of:
receiving information about at least one of the input column attributes and at least one of the output column attributes, said attributes of the input column and output column having a name attribute, wherein names of the input and output columns' name attribute differ;
comparing at least one of the input column attributes to at least one of the output column attributes to determine a likelihood ranking for mapping the input column to the output column, said likelihood ranking indicating a certainty for the mapping that is less than completely certain; and
determining whether to map the input column to the output column based upon the likelihood ranking.

2. The method of claim 1 further comprising the step of:
comparing a portion of an input column attribute to a portion of an output column attribute to determine a likelihood ranking for a mapping between an input column and an output column, wherein said likelihood ranking includes at least one mapping that is between zero and one-hundred percent certain.

3. The method of claim 1 further comprising the step of:
comparing a portion of an input column attribute to an output column attribute to determine the likelihood ranking for a mapping between an input column and an output column, wherein said likelihood ranking includes at least one mapping that is between zero and one-hundred percent certain.

4. The method of claim 1 further comprising the step of:
comparing an input column attribute to a portion of an output column attribute to determine a likelihood ranking for a mapping between an input column and an output column, wherein said likelihood ranking includes at least one mapping that is between zero and one-hundred percent certain.

5. The method of claim 1 further comprising the steps of:
generating fragments of the names of the input column and the output column;
comparing the input column name fragments with the output column name fragments to determine degree of similarity; and
determining the likelihood ranking for mapping the input column to the output column based upon the determined degree of similarity.

6. The method of claim 1 further comprising the steps of:
generating fragments of the names of the input column and the output column;
comparing characters of the input column name fragments with characters of the output column name fragments to determine degree of similarity; and
determining the likelihood ranking for mapping the input column to the output column based upon the determined degree of similarity.

7. The method of claim 6 further comprising the steps of:
generating fragments of the names of the input column and the output column by determining separators in the names.

8. The method of claim 7 wherein the separators are selected from a group of separators consisting of beginning of the names, ending of the names, non-alphanumeric characters in the names, transition between a lowercase letter and an uppercase letter in the names, transition between an alphabetic character and a numeric character in the names, and combinations thereof.

9. The method of claim 1 further comprising the steps of:
determining data types of the input and output columns; and
adjusting the likelihood ranking based upon the determined data types.

10. The method of claim 1 further comprising the steps of:
determining data formats of the input and output columns; and
adjusting the likelihood ranking based upon the determined data formats.

11. The method of claim 10 further comprising the steps of:
retrieving data associated with the input column;
determining the data format of the input column based upon the retrieved data; and
adjusting the likelihood ranking based upon the determined data formats.

12. The method of claim 11 further comprising the steps of:
retrieving data associated with the output column;
determining the data format of the output column based upon the retrieved data; and
adjusting the likelihood ranking based upon the determined data formats.

13. The method of claim 1 wherein a first input column needs to be analyzed to determine whether the first input column maps to a first output column, said method further comprising the steps of:
retrieving previously generated mappings between input columns and output columns; and
determining whether the first input column maps to the first output column based upon searching the previously generated mappings.

14. The method of claim 1 further comprising the steps of:
(i) using predefined mapping means to determine whether the input column maps to the output column;
(ii) using same name mapping means to determine whether the input column maps to the output column; and
(iii) performing step (iv) based upon steps (i) and (ii) not able to map the input column to the output column:
(iv) using character comparison mapping means to determine whether the input column maps to the output column, said character comparison mapping means determining a likelihood ranking for mapping the input column to the output column that is less than completely certain.

15. The method of claim 14 further comprising the steps of:
(v) performing step (vi) based upon steps (i) and (ii) not able to map the input column to the output column:
(vi) using previous mapping means to determine a likelihood ranking for mapping the input column to the output column that is less than completely certain.

16. The method of claim 15 further comprising the steps of:
(vii) performing step (viii) based upon steps (i) and (ii) not able to map the input column to the output column:
(viii) using data format means to determine a likelihood ranking for mapping the input column to the output column that is less than completely certain.

17. The method of claim 16 further comprising the steps of:
(ix) performing step (x) based upon steps (i) and (ii) not able to map the input column to the output column:
(x) using concept cluster mapping means to determine a likelihood ranking for mapping the input column to the output column that is less than completely certain.

18. The method of claim 16 wherein the previous mapping means and data format means execute substantially concurrently.

19. The method of claim 1 further comprising the steps of:
storing in a possible matches list mappings between input and output columns whose likelihood rankings are less than certain; and
storing in an exact matches list mappings between input and output columns whose likelihood rankings are certain.

20. The method of claim 19 further comprising the step of:
storing in the possible matches list at least one of the output columns that is derived from at least one of the input columns.

21. The method of claim 1 wherein the compared attributes of the input column and output column are name attributes of the input column and output column.

22. The method of claim 1 wherein the compared attributes of the input column and output column are verification rule attributes of the input column and output column.

23. The method of claim 1 wherein the compared attributes of the input column and output column are data type attributes of the input column and output column.

24. The method of claim 1 wherein the compared attributes of the input column and output column are data format attributes of the input column and output column.

25. A computer-implemented method for mapping input columns to output columns, said input columns and said output columns having attributes, comprising the steps of:
retrieving data stored in an input column;
examining the retrieved input column data to determine format of the input column;
retrieving data stored in an output column;
examining the retrieved output column data to determine format of the output column;
comparing the determined input column format to the determined output column format to determine a likelihood ranking for mapping the input column to the output column, wherein said likelihood ranking is less than certain; and
generating a mapping between the input column and the output column based upon the likelihood ranking that indicates that the mapping is less than certain.
